(19) United States
(12) Patent Application Publication
(10) Pub. No.: US 2017/0232455 A1
(43) Pub. Date: Aug. 17, 2017

(54) ADAPTER FOR A BLOW GUN AND METHOD OF USING THE SAME

(71) Applicants: Peter A. Grable, CHICAGO, IL (US); Daniel C. Swanson, CHICAGO, IL (US)

(72) Inventors: Peter A. Grable, CHICAGO, IL (US); Daniel C. Swanson, CHICAGO, IL (US)

(21) Appl. No.: 15/412,032

(22) Filed: Jan. 22, 2017

Related U.S. Application Data
(60) Provisional application No. 62/293,889, filed on Feb. 11, 2016.

(51) Int. Cl. B05B 1/02; F16L 37/04; F16L 15/00

(52) U.S. Cl. CPC B05B 1/02; F16L 15/006; F16L 37/04

(57) ABSTRACT

An adapter for a blow gun and a method of using the same is provided. The adapter has a generally cylindrical tube having a first end and a second end wherein the first end of the generally cylindrical tube slides onto the distal tip of a blow gun and is held in place by an internal O-ring/D-ring within the adapter which is secured within a groove on the distal tip of the blow gun. The second end of the adapter has internal threading which may therein receive a variety of various nozzle tips without the need to remove the adapter from the blow gun. An exterior side of the generally cylindrical tube of the adapter has a knurled finish for better grasping and tightening the generally cylindrical tube by hand. The present adapter may allow for the utilization of ⅛″ NPS threaded tips on modern pistol grip blow guns.

### CROSS REFERENCE TO RELATED APPLICATION

The following application is based on and claims the priority benefit of U.S. Provisional Application Ser. No. 62/293,889 filed on Feb. 11, 2016, currently co-pending; the entire contents of which are incorporated by reference.

### BACKGROUND OF THE INVENTION

An adapter for a blow gun and a method of using the same is provided. The adapter has a generally cylindrical tube having a first end and a second end wherein the first end of the generally cylindrical tube slides onto the distal tip of a blow gun and is held in place by an internal O-ring/D-ring within the adapter which is secured within a groove on the distal tip of the blow gun. The second end of the adapter has internal threading which may therein receive a variety of various nozzle tips without the need to remove the adapter from the blow gun. An exterior side of the generally cylindrical tube of the adapter has a knurled finish for better grasping and tightening the generally cylindrical tube by hand. The present adapter may allow for the utilization of ⅛″ NPS threaded tips on modern pistol grip blow guns.

Providing blow guns is known in the prior art. For example, U.S. Pat. No. 6,505,784 to Jou discloses an air blowgun, and more particularly to a blowpipe mechanism of the air blowgun, which can secure with variety nozzles individually for meeting to different purposes. Wherein a thread is set on the tip end of the blowpipe, thereby to connect with an extending long blowpipe, a screen nozzle, a charging adapter, a plug-in charging connector, a low-pressure nozzle, a soft nozzle, or a vent wire and so on to form multifunction tool, and it has small volume, easy mounting and replacing operation and facilitating carryover feathers.

Further, U.S. Pat. No. 6,213,411 to Jou discloses an inlet of a blow gun, and more particularly to a metal inlet combined in a plastic blow gun by injection molding. The metal inlet has an internal screw hole, and a polygonal outside surface or a ratchet-striated outside surface, to provide a high torque-resistant construction when integrally molded with the blow gun. One or more groove rings are formed in the outside surface of the metal inlet, the side walls of the groove ring form retainers to prevent it from moving out axially under a large axial force. The plastic blow gun integrated with the metal inlet has an excellent seal efficiency without any leakage, and the service life is increased greatly.

Still further, U.S. Pat. No. 3,980,238 to Adiletta discloses a filter nozzle is provided for air guns, comprising, in combination, a filter housing, having an air channel therethrough and adapted to be mounted to an air outlet of an air gun, an air nozzle removably attached to the filter housing, in fluid flow connection with the air channel, for restricting and directing the air from the air gun as an air stream; and a filter removably attached to the filter housing across the air channel upstream of the nozzle so that air passing through the channel must pass through the filter before passing through the nozzle.

However, the prior patents fail to describe an adapter for a blow gun which is easy to use and efficient. Further, these patents fail to provide an adapter for a blow gun which allows a user to change the nozzle tip of the blow gun quickly depending on the desired need for a specific application.

### SUMMARY OF THE INVENTION

An adapter for a blow gun and a method of using the same is provided. The adapter has a generally cylindrical tube having a first end and a second end wherein the first end of the generally cylindrical tube slides onto the distal tip of a blow gun and is held in place by an internal O-ring/D-ring within the adapter which is secured within a groove on the distal tip of the blow gun. The second end of the adapter has internal threading which may therein receive a variety of various nozzle tips without the need to remove the adapter from the blow gun. An exterior side of the generally cylindrical tube of the adapter has a knurled finish for better grasping and tightening the generally cylindrical tube by hand. The present adapter may allow for the utilization of ⅛″ NPS threaded tips on modern pistol grip blow guns.

Thus, an advantage of the present adapter for a blow gun is that the present adapter may allow for the utilization of ⅛″ NPS threaded tips on modern pistol grip blow guns.

Yet another advantage of the present adapter is to allow a user to save money by not having to replace all of his/her old ⅛″ NPS threaded nozzle tip collection as a result of them not being able to mate with newer pistol grip blow guns.

An advantage of the present adapter for a blow gun is that the present adapter for a blow gun allows a user to quickly change out the nozzle tip of the blow gun so as to alter the pressure, direction and/or concentration of air exiting the blow gun without the need to remove the adapter from the blow gun.

Another advantage of the present adapter for a blow gun is that the present adapter for a blow gun has a knurled finish for allowing easy installation and removal of the adapter from the blow gun by hand.

Still another advantage of the present adapter for a blow gun is that the present adapter for a blow gun has an internal threading for receiving the threading of various nozzle tips for the blow gun.

Yet another advantage of the present adapter for a blow gun is that the present adapter for a blow gun has an internal O-ring/D-ring which temporarily, but securely, grasps a groove on the distal tip of the blow gun.

And an advantage is that the adapter may be magnetic in an embodiment so as to better be secured to the blow gun and/or the nozzle tips.

Yet another advantage is that the adapter may be secured to the blow gun by friction and may be easily changed without tools.

For a more complete understanding of the above listed features and advantages of the present adapter for a blow gun and a method of using the same reference should be made to the detailed description and the drawings. Further, additional features and advantages of the invention are described in, and will be apparent from, the detailed description of the preferred embodiments.

### BRIEF DESCRIPTION OF THE DRAWINGS

FIG. 1 illustrates a perspective side view of the adapter for a blow gun wherein the adapter and tip are secured together.

FIG. 2 illustrates an exploded view of the nozzle tip, the adapter and the distal end of the blow gun.

FIG. 3 illustrates a perspective side view of the first end of the adapter for a blow gun of the present device.

FIG. 4 illustrates a perspective side view of the second end of the adapter for a blow gun of the present device.

FIG. 5 illustrates a plan view of the adapter for a blow gun.

FIG. 6 illustrates a plan view of a cross section of FIG. 6 of the present adapter in an embodiment.

FIG. 7 illustrates a side perspective view of the adapter being used to secure a variety of different nozzle tips.

### DETAILED DESCRIPTION OF THE PREFERRED EMBODIMENTS

An adapter for a blow gun and a method of using the same is provided. The adapter has a generally cylindrical tube having a first end and a second end wherein the first end of the generally cylindrical tube slides onto the distal tip of a blow gun and is held in place by an internal O-ring/D-ring/washer within the adapter which is secured within a groove on the distal tip of the blow gun. The second end of the adapter has internal threading which may therein receive a variety of various nozzle tips without the need to remove the adapter from the blow gun. An exterior side of the generally cylindrical tube of the adapter has a knurled finish for better grasping and tightening the generally cylindrical tube by hand. The present adapter may allow for the utilization of ⅛″ NPS threaded tips on modern pistol grip blow guns.

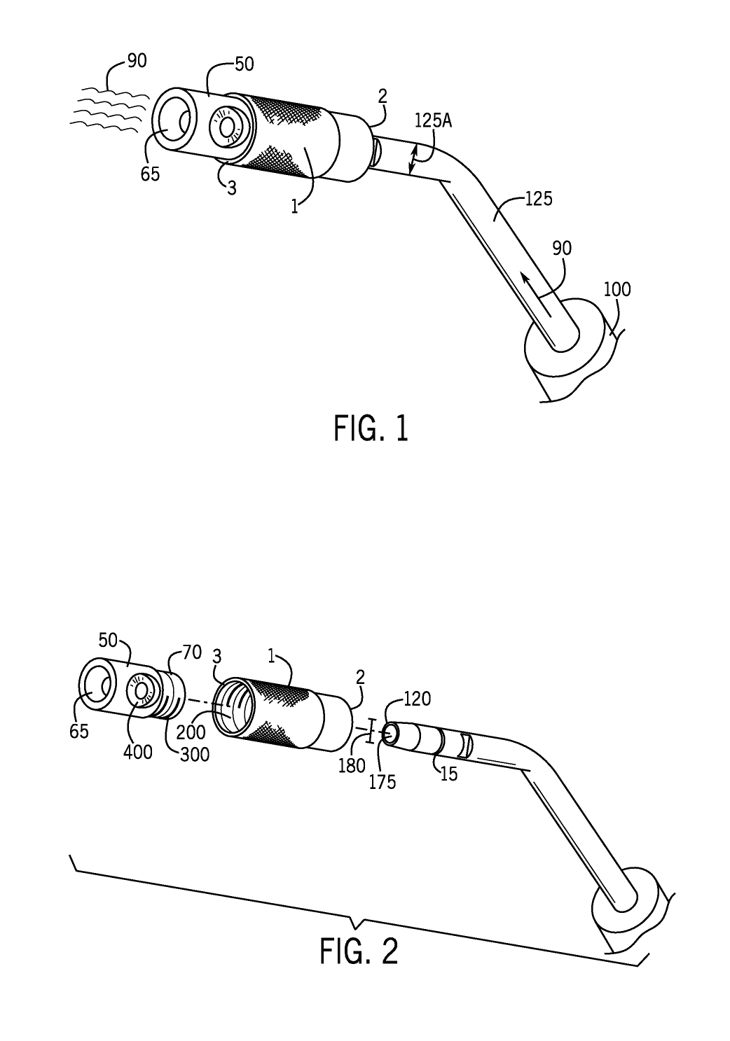

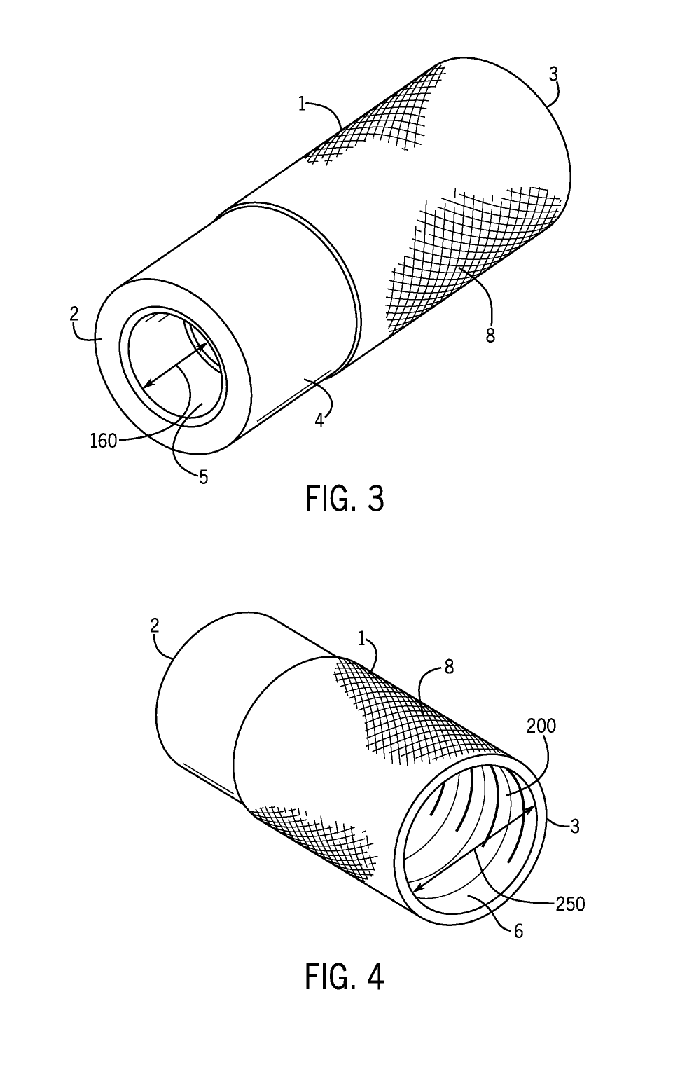

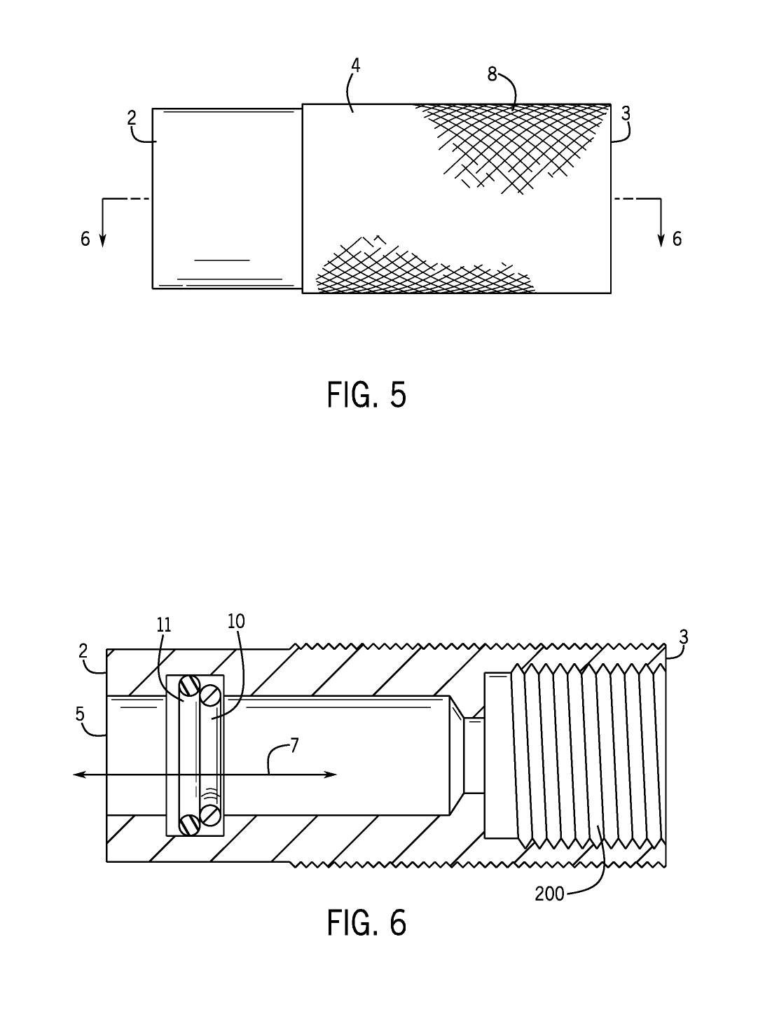

Some previous blow guns have a fixed-tip which cannot be removed from the blow gun. As a result, a user cannot alter the pressure or the size of the air profile exiting the blow gun. Referring first to FIG. 1, in a first embodiment a present adapter 1 for a blow gun 100 (partially shown in FIG. 1) is provided. The blow gun 100 may have a cylindrical tube 125 having a diameter 125A. Pressurized air 90 may enter the blow gun 100 through a flexible tube (not shown) connected to a tank and may exit the blow gun 100 through the cylindrical tube 125 at a second end 120 of the blow gun 100. In an embodiment, the second end 120 may be tapered so as to better accept the adapter 1.

In an embodiment, the adapter 1 is preferably made from a durable metal, such as, for example, anodized aluminum or stainless steel. The adapter 1 may be generally cylindrical having a first end 2, a second end 3 and a cylindrical exterior side (or ‘side’) 4. A first opening 5 may be located at the first end 2 of the adapter 1 and a second opening 6 may be located at the second end 3 of the adapter 1. A channel 7 (or “hollow interior” as shown in FIG. 6) may therein be created within the generally cylindrical adapter 1 wherein the first opening 5 and the second opening 6 create a passageway through the interior of the adapter 1. In an embodiment, the first opening 5 may have a diameter 160 and the second opening 6 may have a diameter 250. In an embodiment, the diameter 160 of the first opening 5 is different from the diameter 250 of the second opening 6. The diameter 160 of the first opening 5 may snuggly fit over the second end 120 of the blow gun 100 wherein the second end 120 of blow gun 100 has an opening 175 having a diameter 180. In particular, the pressurized air 90 may pass through the opening 175 of the blow gun 100 prior to passing through the adapter 1 and then finally through a nozzle tip 50, as described below.

In an embodiment, within the hollow interior 7 of the adapter 1 may be an O-ring/D-ring having a first unit 11 and a second unit 10 (FIG. 6). A portion of the O-ring/D-ring first unit 11 and second unit 10 may corresponding lock onto and may be temporarily secured to a cylindrical groove 15 (FIG. 2) located on generally cylindrical tube 125 near the second end 120 of most blow guns 100 on the market. The O-ring/D-ring first unit 11 and second unit 10 may be slightly undersized so as to snap down into the groove 15. In particular, the O-ring/D-ring first unit 11 and second unit 10 of the adapter 1 may be secured to the generally cylindrical tube 125 of the second end 120 of the blow gun 100 by, for example, temporarily snapping onto the groove 15 and being secured within the groove 15 by friction. To secure the adapter 1 to the generally cylindrical tube 125 the first end 2 of the adapter 1 is secured over and partially conceals a portion of the generally cylindrical tube 125. In an embodiment, the O-ring/D-ring is located on the opposing side from a threaded portion 200 (as discussed below) so as to better secure the adapter 1 to the blow gun 100. More specifically, locating the O-ring/D-ring on the opposing interior side of the adapter as the threaded member 200 results in the two securing mechanisms (the O-ring/D-ring and threaded member 200) being spaced apart and thus causing less wobble and more tightness while the adapter 1 is in use. This helps prevent the accidental falling off of the adapter 1 from the blow gun 100 and/or the nozzle 50 (as discussed below).

In one embodiment, the cylindrical exterior side 4 of the adapter 1 may have a knurled-finish surface 8. The knurled-finish surface 8 may allow a user to easily grip and twist and secure the adapter 1 to the cylindrical tube 125 of the blow gun 100 by use of hand twisting (as opposed to tools). Further, in one alternative embodiment, the adapter 1 may be magnetic so as to better be secured to the generally cylindrical tube 125 of the blow gun 100 and/or so as to be better secured to the nozzle tips 50; both of which may be metal and attracted to magnets. In an embodiment, the knurled-finished surface 8 may not extend the entire length of the adapter 1. As a result, a user may easily determine the correct end of the adapter 1 to secure to the blow gun 100.

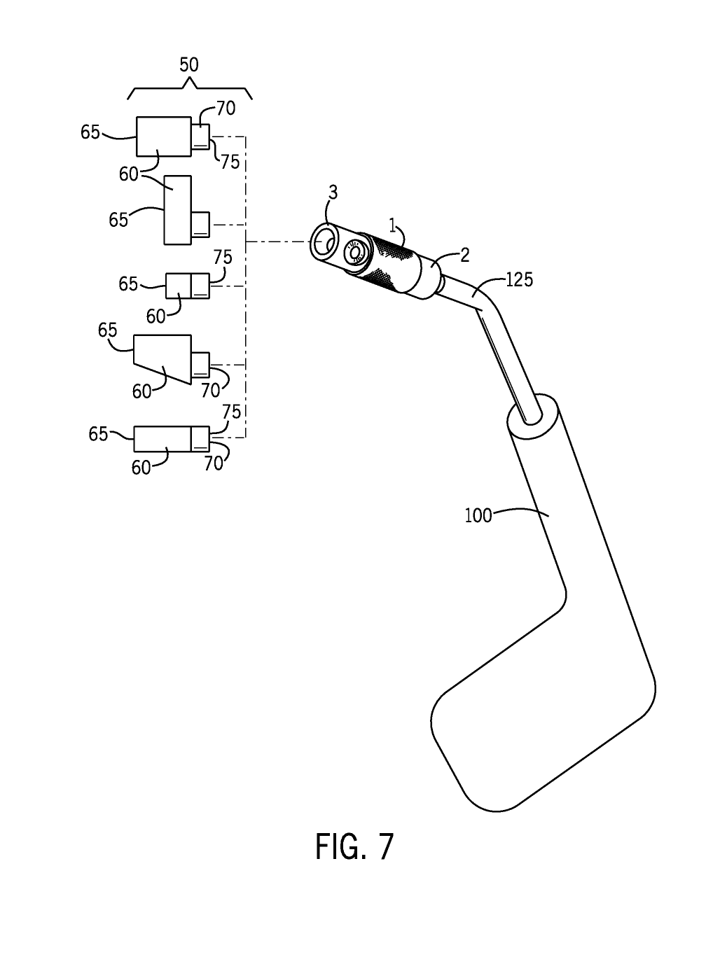

Referring now to FIG. 7, a plurality of various different tips (or “nozzles”) 50 may be temporarily secured to the same adapter 1 which may, in-turn, may be secured to generally cylindrical tube 125 of the blow gun 100. In particular, the various different tips 50 may each have a different first end configuration 60 while having an identical second end configuration 70 wherein the second end configuration 70 has an opening 75. More specifically, the first end configuration 60 of the various tips 50 may each have an opening 65 (for releasing the pressurized air 90) having a different diameter (and/or shape) which is different while the second end configuration 70 of all the various tips 50 may be identical so as to be able to be uniformly secured to the second end 3 of the adapter 1. As a result, if a user selects a nozzle tip 50 which has a smaller opening diameter 65, the air pressure exiting that nozzle tip 50 may be concentrated and therein have an increased pressure and decreased profile while if a user selects a nozzle tip 50 having a greater diameter, the air pressure exiting that nozzle tip 50 will be decreased and the air 90 will have an increased profile. As a result, the present adapter 1 for a blow gun 100 allows a user to quickly change out the nozzle tip 50 of the blow gun 100 so as to alter the pressure, direction and/or concentration of air exiting the blow gun 100 without the need to remove the adapter 1 from the blow gun 100. It is understood that the illustrated nozzle tips 50 of FIG. 7 represent only a tiny fraction of the possible various nozzle tips 50 out in the marketplace. The present device 1 is intended to make utilizing the vast amount of various nozzle tips 50 in existence possible with the present adapter 1.

In an embodiment, the hollow interior 7 may have a threaded portion 200. More specifically, the threaded portion 200 may be located at the second end 3 of the adapter 1 wherein the threaded portion 200 has a diameter 250 (FIG. 4). The threaded portion 200 may be standardized accepting a threaded portion 300 (FIG. 2) of the second end configuration 70 of the tip 50. As a result, the threaded portion 200 of the adapter 1 may be used in connection with various nozzle tips 50 since a wide variety of nozzle tips 50 on the market utilize a similar threaded portion 300. As a result, a user may easily swap out a specific nozzle tip 50 for an alternative nozzle tip 50 depending on the specific job required.

More specifically, many existing nozzle tips 50 on the market utilize ⅛″ NPS threading which were initially developed for old-school thumb switch style blow guns. The threaded portion 200 of the second end 3 of the present adapter 1, in one embodiment, may thus correspondingly accept the standard ⅛″ NPS threading of those existing nozzle tips 50. As a result, the present adapter 1 may allow for the utilization of ⅛″ NPS threaded tips on modern pistol grip blow guns. This allows a user of a new pistol grip style blow gun having an adapter 1 to utilize his/her old nozzle tips 50 without needed to replace his/her entire nozzle tip collection. In one embodiment, the nozzle tip 50 may utilize OHSA compliant openings 400 (FIG. 2) which allows air 90 to escape out of the side of the nozzle tip 50 in the event the nozzle tip 50 becomes blocked.

In an embodiment, a blow gun system having a removable nozzle tip 50, an adapter 1 and a blow gun 100 is provided. The blow gun 100 of the system has a groove 15 which temporarily receives an O-ring/D-ring portion having first unit 11 and second unit 10 located within the adapter 1 of the system. The adapter has a securing mechanism 200 which is capable of receiving and temporarily securing various nozzle tips 50 of the system. As a result, a user may utilize the blow gun 100 which various nozzle tips 50 and the same adapter 1.

Although embodiments of the invention are shown and described therein, it should be understood that various changes and modifications to the presently preferred embodiments will be apparent to those skilled in the art. Such changes and modifications may be made without departing from the spirit and scope of the invention and without diminishing its attendant advantages.

I claim:

1) An adapter for a blow gun comprising:
a first unit having a first end, a second end, an interior and length created between the first end and the second end of the first unit;
an exterior side wall of the first unit;
an opening having a diameter at the first end of the first unit and an opening having a diameter at the second end of the first unit;
a hollow passageway extending from the opening of the first end to the opening of the second end and extending through the first unit;
a threaded member located within the hollow passageway of the first unit at the first end of the first unit wherein the threaded member is capable of receiving a nozzle tip of a blow gun; and
an O-ring/D-ring located within the interior of first unit in the hollow passageway wherein the O-ring/D-ring is capable of temporarily being secured to a groove on a shaft of the blow gun.

2) The adapter for the blow gun of claim 1 wherein a portion of the exterior side wall is knurled.

3) The adapter for the blow gun of claim 1 wherein the diameter of the first opening at the first end of the first unit is different from the diameter of the second opening at the second end of the first unit.

4) The adapter for the blow gun of claim 1 wherein the first unit is magnetic.

5) The adapter for the blow gun of claim 1 wherein the knurled portion of the exterior side wall of the adapter does not extend the full length of the first unit.

6) The adapter for the blow gun of claim 1 wherein the second end of the first unit is capable of accepting a nozzle tip having a ⅛″ NPS threaded tip.

7) The adapter for the blow gun of claim 1 wherein the adapter is made from anodized aluminum or stainless steel.

8) A system for utilizing various nozzle tips in connection with a blow gun, the system comprising:
a blow gun having an elongated hollow tube having a distal end having an opening wherein compressed air exits the blow gun through the opening of the distal end of the blow gun;
a grove located on an exterior of the elongated hollow tube of the blow gun;
an adapter removable and capable of being temporarily secured to the elongated hollow tube of the blow gun wherein the adapter has a first end and a second end and a first opening at the first end and an opening at the second end and a generally hollow interior; and
a removable nozzle tip having a first end and a second end and a first opening at the first end and a second opening at the second end and a generally hollow interior having an exterior surface;
wherein the removable nozzle tip is temporarily removable secured to the adapter; and
wherein the adapter is located between the removable nozzle tip and the blow gun in the functional system.

9) The system for utilizing various nozzle tips in connection with a blow gun of claim 8 wherein the nozzle tip is partially cylindrical.

10) The system for utilizing various nozzle tips in connection with a blow gun of claim 8 further comprising:
a third opening on exterior side of the removable nozzle tip wherein the third opening of the exterior side of the removable nozzle tip releases pressurized air passing through the removable nozzle tip.

11) The system for utilizing various nozzle tips in connection with a blow gun of claim 8 wherein the distal end of the blow gun is tapered.

12) The system for utilizing various nozzle tips in connection with a blow gun of claim 8 further comprising:
a threaded portion located in the generally hollow interior of the adapter wherein the threaded portion correspondingly mates with a threaded portion of the removable nozzle tip and temporarily secures the removable nozzle tip to the adapter.

13) The system for utilizing various nozzle tips in connection with a blow gun of claim 8 wherein the adapter is magnetic.

14) The system for utilizing various nozzle tips in connection with a blow gun of claim 8 wherein the adapter is made from anodized aluminum or stainless steel.

15) The system for utilizing various nozzle tips in connection with a blow gun of claim 8 wherein the second end of the adapter is capable of accepting removable nozzle tips having a ⅛″ NPS threaded tip.
